(19) United States
(12) Patent Application Publication
(10) Pub. No.: US 2007/0039957 A1
(43) Pub. Date: Feb. 22, 2007

(54) Storage containers for vehicles

(76) Inventors: Shawn Shulz, Polk City, IA (US); Matt Guerdet, Ankeny, IA (US); Rob Nagengast, Ankeny, IA (US)

Correspondence Address: DINSMORE & SHOHL, LLP, 1900 CHEMED CENTER, 255 EAST FIFTH STREET, CINCINNATI, OH, 45202, US

(21) Appl. No.: 11/208,154

(22) Filed: Aug. 19, 2005

(51) Int. Cl. B65D 45/16; B65D 55/14; B60R 9/00; B60R 7/00

(52) U.S. Cl. 220/210; 224/404; 220/324

(57) ABSTRACT

In one embodiment a storage container for a vehicle is provided that includes a protective member or a channel of increased stability. The container includes a plurality of walls defining an interior storage space, a closable lid configured to be selectively opened and closed to enclose the interior storage space. The closable lid includes a latch mechanism and a locking assembly provided along an interior of a first one of the walls and extending inwardly toward the interior storage space, the locking assembly being configured to engage the latch mechanism of the closable lid. A protective member extends relative to the first one of the walls adjacent the locking assembly, the protective member extending further toward the interior storage space than does the locking assembly, wherein at least at least a portion of the protective member extends relative to the first one of the walls at an angle that is neither parallel nor perpendicular to the first wall.

### FIELD OF THE INVENTION

This invention relates to storage containers for vehicles, and more particularly, in one embodiment, to tool boxes for trucks having enhanced structural support.

### BACKGROUND OF THE INVENTION

Storage containers such as truck tool boxes are used to store and secure a variety of tools and other items conveniently in the bed of a truck. There are a number of different types of tool boxes including chest boxes, crossover boxes, sidemount boxes and others. Each tool box is typically formed of aluminum plate, and comprises a plurality of walls defining an interior space. The tool box interior is closed by a lid pivotal on a hinge between an open position and a closed position. In order to lock the lid and secure the contents of the truck box, most aluminum truck boxes include a pair of locks mounted at opposite ends of the front wall in position to releasably engage corresponding latches associated with the lid.

Certain truck tool boxes are moveable about the truck beds via corresponding tracks and/or rollers associated with the boxes and the beds. For example, if a consumer desires to pull a crossover tool box toward the rear of the bed, the consumer will often grab onto the front wall of the box and pull the box rearward. As expected, such action requires some force to be applied to the front wall in order to maneuver the tool box, and this force can eventually damage the box itself and/or working components associated with the box. For example, because many conventional tool boxes comprise a basic C-channel around the upper periphery of the box, a strong force asserted at the center of the front wall is likely to bow the periphery. Bowing may eventually prevent the lid from latching to the locks within the channel when the lid is moved to a closed position, or in some situations, prevent the lid from unlatching when in a closed, locked position. In addition, because the box locks are often positioned within the C-channel, the same forces described above, or more often, moving tolls within the box, may cause portions of the C-channel to interfere with or damage the locks.

Accordingly, there is a need for a truck tool box designed to enhance structural stability of the box, as well as protect components such as locks associated with the box.

### SUMMARY OF THE INVENTION

Accordingly, the present invention is intended to address and obviate problems and shortcomings and otherwise improve previous storage containers for vehicles, including truck tool boxes.

In accordance with some embodiments, a storage container for a vehicle is provided which includes a plurality of walls defining an interior storage space, a closable lid configured to be selectively opened and closed to enclose the interior storage space, the closable lid including a latch mechanism. A locking assembly is provided along an interior of a first one of the walls and extends inwardly toward the interior storage space, the locking assembly being configured to engage the latch mechanism of the closable lid. The storage container of this embodiment also includes a protective member extending relative to the first one of the walls and adjacent the locking assembly, the protective member extending further toward the interior storage space than the locking assembly. At least a portion of the protective member extends relative to the first one of the walls at an angle that is neither parallel nor perpendicular to the first wall.

In accordance with other illustrative embodiments, a storage container for a vehicle is provided that includes a front wall, a back wall and opposed side walls all interconnected to form a hollow interior storage space and a protective member including a ledge extending substantially horizontally from the front wall toward the interior storage space. An inclined piece extends toward the interior space and is positioned at an angle of less than 90 degrees relative to the ledge.

In accordance with other illustrative embodiments, a storage container for a vehicle is provided that includes a plurality of walls defining an interior storage space, a closable lid configured to be selectively opened and closed to enclose the interior storage space, the closable lid including a latch mechanism and a locking assembly provided along an interior of a first one of the walls and extending inwardly toward the interior storage space, the locking assembly being configured to engage the latch mechanism of the closable lid. The storage container also includes a protective member including a ledge extending substantially horizontally from the front wall toward the interior storage space and an inclined piece extending toward the interior space, wherein the inclined piece extends relative to the first one of the walls at an angle that is neither parallel nor perpendicular to the first wall.

Still other aspects and inventive principles will become apparent to those skilled in the art from the following descriptions wherein there are shown and described alternative embodiments, solely for illustration purposes. As will be realized, other different embodiments can be provided without departing from the scope of a particular aspect or principle. Accordingly, the drawings, objects, and description should be regarded as illustrative and exemplary in nature only and not as restrictive.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a side perspective view of one illustrative embodiment of a storage container with the lid in an open position made in accordance with principles of the present invention;

FIG. 2 is a cross-sectional view taken along 2-2 of FIG. 1;

FIG. 3 is an enlarged view of an illustrative embodiment of a protective member with an exemplary lock assembly, the embodiment being made in accordance with at least one principle of the present invention;

FIG. 4 is a side perspective view of an additional exemplary embodiment of a storage container made in accordance with at least one principle of the present invention;

FIG. 5 is a cross-sectional view taken along 5-5 of FIG. 4, with an added lock assembly for illustration;

FIG. 6 is a side perspective view of an additional exemplary embodiment of a storage container made in accordance with at least one principle of the present invention;

FIG. 7 is a cross-sectional view taken along 7-7 of FIG. 6 with an added lock assembly for illustration.

### DETAILED DESCRIPTION OF EXEMPLARY EMBODIMENTS

Referring to the drawing figures in detail, wherein like numerals indicate the same elements throughout the drawing figures, FIG. I illustrates an exemplary storage container 10. As illustrated, storage container 10 may comprise a body 12 having the general exterior shape of a crossover style vehicle tool box and include a plurality of walls such as a first or front wall 20, two opposed side walls 22 and 24, a rear wall 26 and a bottom wall 28. The plurality of walls may be joined together to form an interior storage space 30. If desired, body may comprise one or more tracks or rollers so that container may be moveable about the vehicle. As illustrated, one or more locking assemblies 32 may be mounted or otherwise secured along the front wall 20. Locking assemblies 32 may comprise mechanisms configured to secure a closable lid (described below) in a closed position. More particularly, locking assemblies 32 may include a lock 34 (best seen in FIG. 3) positioned along the interior of the front wall 20. Lock 34 may be associated with release 36 positioned on the exterior 38 of front wall 20. A key opening may be provided for receiving a key to lock and unlock the lock 34.

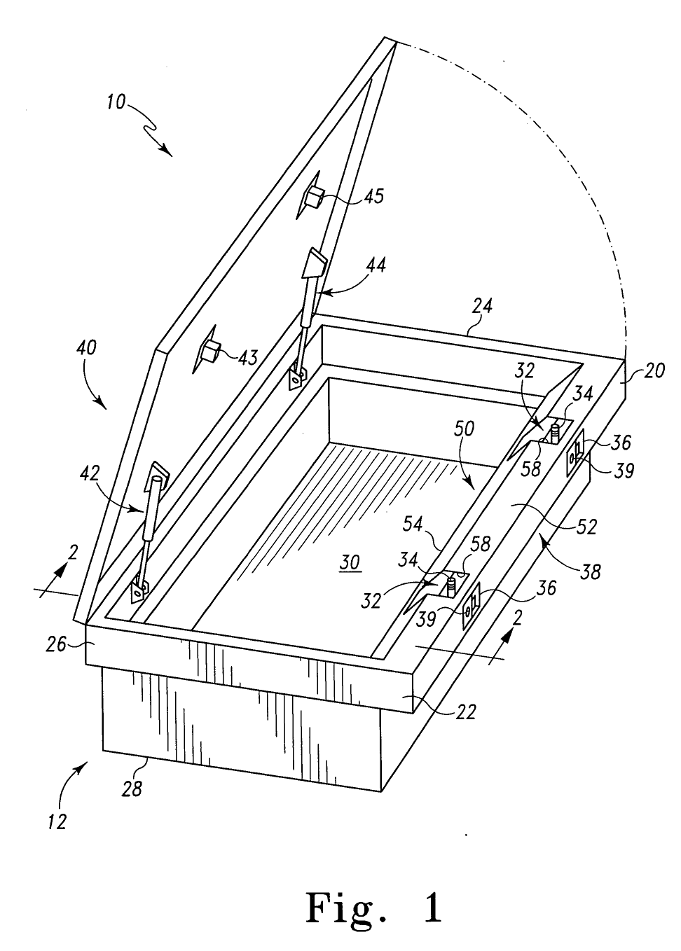

Storage container 10 may also include a closable lid 40 pivotally connected to the body 12 and configured to be selectively opened and closed to cover or expose the interior storage space 30. As illustrated in FIG. 1, the lid 40 is in an open position. One or more tension assemblies 42 and 44, may be pivotally secured between the body 12 and the lid 40 in order to limit how far the lid 40 can open relative to the body 12 and to dampen the movement of the lid 40 toward or away from the body 12. Lid may also comprise one or more latch mechanisms 43 and 45 configured to engage the locking assemblies 32 located on the interior of front wall 20. It should be understood, that while locking assemblies 32 and latch mechanisms 43 and 45 are illustrated as being located on the front wall, locking assemblies 32 and latch mechanisms 43 and 45 may similarly be located on the opposed sidewalls 24 and 26 so that locking and releasing the lid 40 can be done on the side of the container 10.

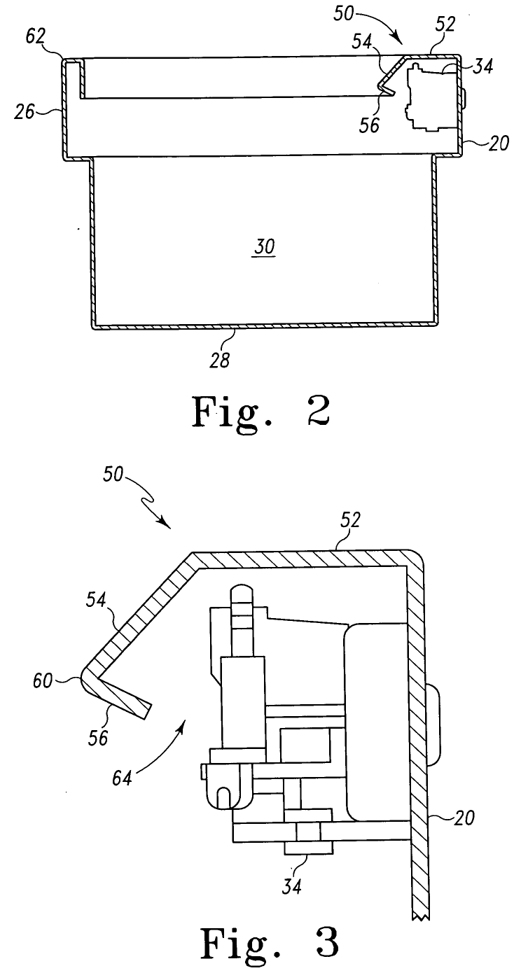

In order to enhance the structural stability of at least the front wall and to protect the lock 34 from damage, container 10 may comprise a protective member 50. Referring to FIGS. 1-3, protective member 50 can include a ledge 52, an inclined piece 54 and an extension piece 56. Protective member 50 may also include one or more openings or lock voids 58 cut therein to provide access to lock 34. The number of lock voids 58 depends on the number of associated locks 34. In one embodiment, the ledge 52, inclined piece 54 and extension piece 56 of the protective member 50 may comprise an integral sheet of metal or plastic bent or molded into the exemplary shape illustrated to yield a desired protective member 50. Of course, in another embodiment, the ledge 52, inclined piece 54 and extension piece 56 of the protective member 50 may comprise unitary pieces secured together.

As illustrated, ledge 52 may extend horizontally from and be substantially perpendicular to the front wall 20. By substantially perpendicular or horizontal it is meant that the angle between the front wall 20 is at about 90° or a small variation therefrom. Ledge 52 may extend approximately 2″ into the interior storage space 30, however, ledge 52 may extend any distance into the interior space 30 in another embodiment. In addition, ledge 52 may be welded or otherwise secured to the opposed sidewalls 24 and 26. In another embodiment, ledge 52 may be eliminated so that inclined piece 54 extends directly from the front wall 20.

Inclined piece 54 may further extend into interior space 30 at an angle different than the ledge 52. Accordingly, inclined piece 54 extends relative to a first or front wall at an angle that is neither parallel nor perpendicular to said front wall. As illustrated, the angle of the inclined piece 54 may be 45° relative to the front wall 20 and the ledge 52. Of course, it should be understood that the angle of the inclined piece 54 relative to the front wall 20 may be any angle that is neither parallel nor perpendicular to the front wall (i.e., less than 90, about 30 to about 65 or about 20 to about 70, to name a few examples). In addition, inclined piece 54 may be welded or otherwise secured to the opposed sidewalls 24 and 26.

Extension piece 56 of protective member 50 may extend from the inclined piece 54 back toward the front wall 20. It is contemplated that extension piece 56 may comprise any angle relative to the front wall 20 or the other parts of the protective member 50. Although the extension piece 56 may be eliminated in another embodiment, extension piece 56 can be added to edge 60 of the inclined piece 54 to provide a more comfortable gripping surface for a consumer maneuvering the container 10. In addition, although not necessary, extension piece 54 may be welded or otherwise secured to the opposed sidewalls 24 and 26.

The implementation of a protective member 50 and the orientation of the protective member components can provide one or more advantages. First, the protective member 50 can enhance the structural stability of the container, and more particularly, the front wall 20. In the past, containers for vehicles comprising a c-channel 62 extending the entire periphery of the container. Accordingly, when a consumer pulled the heavy box from location to another, the inner wall of the hollow c-channel could collapse and the front wall buckle or bow. By extending the ledge 52 of the protective member 50 and adding an inclined piece 54, the channel created by the protective member is less likely to collapse under a force applied to the container, and thus, the front wall 20 is less likely to buckle or bow. In addition, because the ledge 52 and the inclined piece 54 can be secured to the opposed walls 22 and 24 in an orientation extending downward into the interior space 30 and toward the back wall 26, the front wall is better anchored to the remainder of the container in contrast to previous c-channel arrangements which were secured to sidewalls at or near the periphery of the container. In such embodiments, the weld or other securing arrangement may extend from the ledge 52 to the inclined piece 54 a total distance greater than that of conventional c-channel arrangements. For example, in one embodiment, the weld of the ledge may be 2.25 inches, the weld of the inclined piece may be 2.5 inches and the weld of the extension piece may be 0.5 inches. Accordingly, the weld or other securing arrangement may extend along the length of at least one of the sidewalls approximately 5.25 inches. However, these exemplary lengths should not be limiting, and in another embodiment, can comprise a total length of, for example 4.5 inches.

The described implementation of a protective member 50 and the orientation of the protective member components also serves to protect the lock 34. Referring to FIG. 3, the orientation of the ledge 52 and the inclined piece 54 create a channel 64 to house the lock 34. In such embodiment, the protective member extends further toward the interior space than does the lock. As previously discussed, prior containers for vehicles comprised hollow c-channels that could collapse under pressure not only from a consumer applying a force to maneuver the container, but also by moving parts within the interior of the container. When the prior c-channels collapsed, the lock, often housed within the c-channels would be damaged. By configuring the protective member 50 in the orientation discussed, or in alternatives suggested, the channel created for the lock 34 is more rigid and not as easily collapsible. In addition, although the inclined piece 54 is illustrated as only extending downward to shield a portion of the lock vertically, the inclined piece may be extended any distance within the interior space to fully shield and or house the lock.

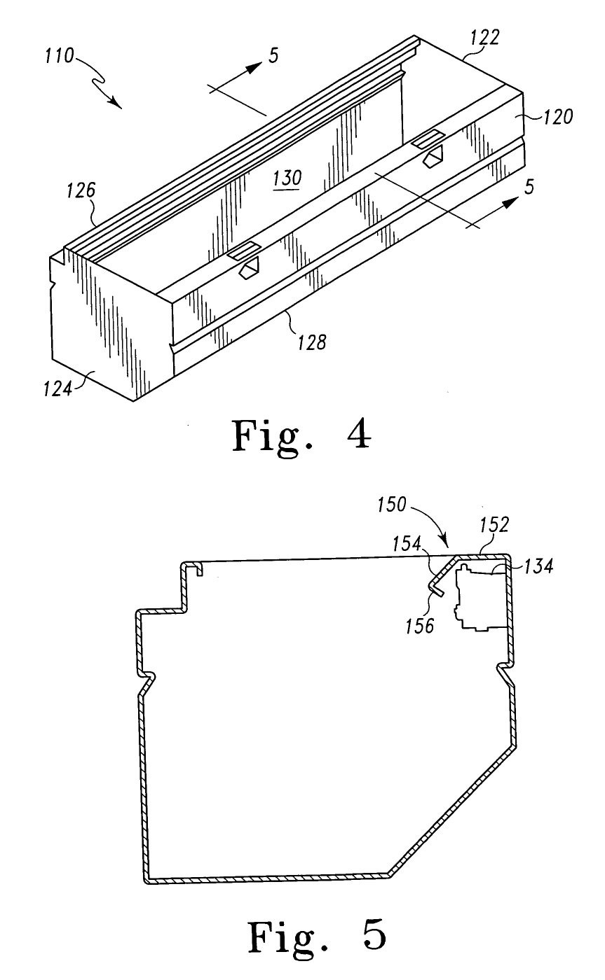

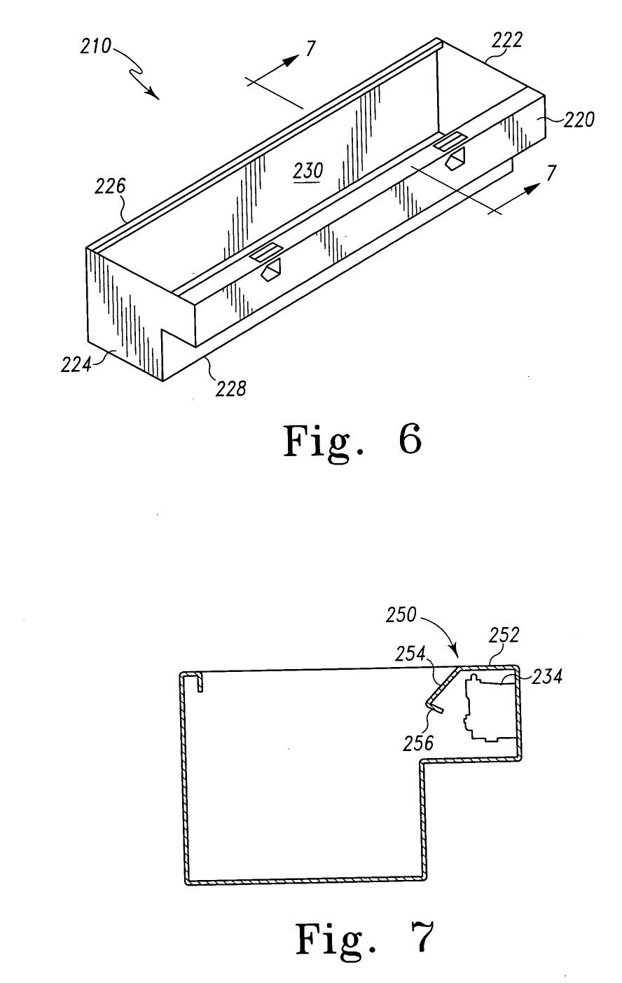

Another potential advantage of the illustrated protective member is that it can be added to a variety of containers for vehicles. For example, referring to FIGS. 4-5, a storage container 110 having the general exterior shape of a chest style vehicle tool box is illustrated. The container 110 similarly comprises front wall 120, two opposed side walls 122 and 124, a rear wall 126 and a bottom wall 128 joined together to form an interior storage space 130. Container 110 similarly comprises a protective member 150 including a ledge 152, an inclined piece 154 and an extension piece 156. In addition, referring to FIGS. 6-7, a storage container 210 having the general exterior shape of a sidemount style vehicle tool box is illustrated. The container 210 similarly comprises front wall 220, two opposed side walls 222 and 224, a rear wall 226 and a bottom wall 228 joined together to form an interior storage space 230. Container 210 similarly comprises a protective member 250 including a ledge 252, an inclined piece 254 and an extension piece 256. Protective members 50, 150 and 250 may be incorporated into a variety of other containers for vehicles as well.

It should be understood that while the exemplary embodiments illustrate the incorporation of a protective member adjacent the front wall of a container, the protective member may be incorporated into any other wall, or in another embodiment, all walls for a vehicle container, and particularly a truck tool box. For example, for a moveable sidemount style box, it may be desired to add a protective member to sidewall 222 and/or 224 if it is a sidewall, rather than a front wall, that consumers often grab to maneuver the box. In such embodiment, locks 234 may be located along the interior of the side wall so as to benefit from the protection afforded by the channel of the protective member. However, because the protective member shown can both enhance structural stability and protect the lock, the protective member may be utilized for one or both of these benefits in a vehicle container. In addition, it should further be understood that while the protective member is illustrated as comprising both the ledge and inclined piece, an inclined piece can be provided that extends directly from a wall at an angle that is neither parallel nor perpendicular to that wall.

The foregoing description of the various embodiments showing the inventive principles has been presented for the purposes of illustration and description. It is not intended to be exhaustive or to limit the invention to the precise form disclosed. Many alternatives, modifications and variations will be apparent to those skilled in the art of the above teaching. For example, the protective members described herein may be implemented in a number of vehicle containers in a plurality of orientations.

Accordingly, while some of the alternative embodiments of the storage containers for vehicles have been discussed specifically, other embodiments will be apparent and can be developed by those of ordinary skill in the art. Accordingly, this patent is intended to embrace all alternatives, modifications and variations that have been discussed herein, and others that fall within the spirit and broad scope of the claims.

What we claim is:

1. A storage container for a vehicle, said container comprising:
a plurality of walls defining an interior storage space;
a closable lid configured to be selectively opened and closed to enclose said interior storage space, said closable lid including a latch mechanism;
a locking assembly provided along an interior of a first one of said walls and extending inwardly toward said interior storage space, wherein said locking assembly is configured to engage said latch mechanism of said closable lid; and
a protective member extending relative to said first one of said walls adjacent said locking assembly, wherein said protective member extends further toward said interior storage space than does said locking assembly, wherein at least at least a portion of said protective member extends relative to said first one of said walls at an angle that is neither parallel nor perpendicular to said first wall.

2. The container as recited in claim 1, wherein said angle is from about 30 degrees to about 65 degrees.

3. The container as recited in claim 1, wherein at least a portion of said protective member is secured to a second of said walls.

4. The container as recited in claim 1, wherein said protective member includes a ledge extending at a right angle to a top of said first wall and an inclined piece extends at an angle of from about 20 to about 70 from said ledge, wherein said locking assembly is positioned below said ledge and outward relative to said inclined piece.

5. The container as recited in claim 4, wherein said inclined piece extends at an angle of about 45 degrees from said ledge.

6. The container as recited in claim 4, wherein said protective member further includes an extension piece extending in an outward direction from said inclined piece toward the exterior of said box.

7. The container as recited in claim 6, wherein said inclined piece and said extension piece are secured to a second of said walls.

8. The container as recited in claim 1, wherein said locking assembly includes a key opening and is configured to be disengaged from said latch mechanism via a key.

9. The container as recited in claim 1, wherein said protective member includes at least one opening for providing access to said locking assembly.

10. The container as recited in claim 1, wherein the container is moveable about said vehicle.

11. A storage container for a vehicle, said container comprising:
a front wall, a back wall and opposed side walls all interconnected to form a hollow interior storage space; and
a protective member including;
a ledge extending horizontally from one of said walls toward said interior storage space; and
an inclined piece extending toward said interior space and positioned at an angle of less than 90 degrees relative to said ledge.

12. The container as recited in claim 11, wherein said ledge and said inclined piece are secured to at least one of said opposed walls.

13. The container as recited in claim 11, wherein said protective member further includes an extension piece secured to said inclined piece and extending toward said front wall.

14. The container as recited in claim 11, wherein said angle is about 45 degrees.

15. The container as recited in claim 11, wherein said protective member includes at least one lock void for providing access to a lock assembly positioned below said ledge and outward relative to said inclined piece.

16. The container as recited in claim 15, further including a closable lid configured to be selectively opened and closed to enclose said interior storage space, said closable lid including a latch mechanism, wherein said locking assembly is configured to engage said latch mechanism of said closable lid.

17. The container as recited in claim 11, wherein the container is moveable about said vehicle.

18. A storage container for a vehicle, said container including:
a plurality of walls defining an interior storage space;
a protective member extending toward said interior space relative to a first one of said walls at an angle that is neither parallel nor perpendicular to said first wall, wherein at least a portion of said protective member is secured along a length of a second one of said walls approximately 4.75 inches.

19. The container as recited in claim 18, wherein said protective member includes a ledge, said ledge being secured along a length of said second wall approximately 2.25 inches.

20. The container as recited in claim 18, wherein said protective member includes an inclined piece, said inclined piece being secured along a length of said second wall approximately 2.5 inches.
